(19) United States
(12) Patent Application Publication
(10) Pub. No.: US 2007/0297805 A1
(43) Pub. Date: Dec. 27, 2007

(54) OPTICAL COMMUNICATION SYSTEM WITH CATS-EYE MODULATING RETRO-REFLECTOR (MRR) ASSEMBLY, THE CATS-EYE MRR ASSEMBLY THEREOF, AND THE METHOD OF OPTICAL COMMUNICATION

(76) Inventors: William Rabinovich, Silver Spring, MD (US); G. Charmaine Gilbreath, Burke, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 11/426,087

(22) Filed: Jun. 23, 2006

(51) Int. Cl. H04B 10/00

(52) U.S. Cl. 398/151

(57) ABSTRACT

An optical communicating system and method thereof includes first and second terminals. The first terminal has a transmitter for transmitting an interrogating light beam and a receiver for receiving the interrogating light beam. The second terminal has a cats-eye modulating retroreflector (MRR), which includes a modulator for modulating the interrogating light beam received from the transmitter an optical focusing device for focusing the interrogating light beam from the transmitter to the modulator, and a reflector for reflecting the modulated light beam to the receive. It can include a beam deflector positioned at the aperture of the optical focusing device of the catseye MRR to reduce the field of view of the cats-eye MRR, It can also include an angle of arrival sensor for sensing the angle of arrival of the interrogating beam at the second terminal. One or more pixels of the modulator can be activated to permit the activated pixel(s) to modulate the interrogating beam, which is reflected back to the receiver, and the beam deflector both can be controlled based on the angle of arrival detected

### BACKGROUND

A modulating retro-reflector (MRR) is a device that allows free space optical communication without any pointing or tracking at a remote or distal end of the link. The MRR typically includes passive optical retro reflectors coupled with electro-optic modulators to allow long-range, free-space optical communication with a laser, and a pointing or acquisition or tracking system required only at one end of the link. In operation, the one end of the communication link includes a conventional free space optical communication terminal with an interrogator for illuminating the MRR on the remote or other end of the link with a continuous wave (CW) beam, The MRR imposes a modulation on the interrogating CW beam and passively retro reflects it back to the interrogator. The above types of systems are attractive for asymmetric communication links where one end of the link cannot afford the weight, power, or expense of a conventional free space optical communication terminal.

Conventional MRRs use a modulator having a large area placed in front of the aperture, or as one of the faces, of a corner-cube retro-reflector MRR. In this respect, ferro-electric liquid crystals, MEMS devices, and multiple quantum well (MQW) electro-absorption modulators have been contemplated. For both the liquid crystal and MEMS devices, the maximum modulation rate is set by the intrinsic switching speed of the material, which speed is typically tens of KHz and hundreds of KHz, respectively. For the MQW MRR, the maximum modulation can range into the gigahertz, limited only by the resistance and capacitance (RC) time constant of the device. This limits the surface area of the MQW; the smaller the surface area, the lower the capacitance and the power requirement. The optical aperture of the MRR, however, cannot be too small as the amount of light retro reflected will be insufficient to close the link. For typical MQW MRR devices, the modulator has a diameter between 0.5-1.0 cm and maximum modulation rates less than 10 MHz. Thusly sized device is sufficient to close the link at this rate at ranges over ten kilometers, depending on atmospheric conditions and the interrogator.

U.S. Pat. No. 6,154,299, the disclosure of which is incorporated herein by reference, discloses a cats-eye MRR that overcame the above limitation by using a cats-eye modulating MRR to focus the light into a smaller area than the optical aperture. A cats-eye MRR can be defined as a combination of tenses and mirrors having the property of passively retro-reflecting light, An example of a cats-eye MRR is a telecentric lens with a flat mirror placed in or at the focal plane and oriented with the surface normal parallel to the optic axis of the lens. This permits use of a MQW modulator having a smaller area than the optical aperture. Even though the cats-eye optical focusing device can focus the light tightly, the position of the focal spot changes with the incident angle. Therefore, the size of the MQW modulator needs to be large enough to encompass the entire region where the focused light might fall.

It would be desirable to reduce the size of the modulator to reduce the power consumption and improve the performance of a cats-eye MRR. The present invention addresses this need.

### SUMMARY OF THE INVENTION

The present invention relates to an optical communication system having a cats-eye modulating retro-reflector (MRR) assembly, the cats-eye MRR assembly thereof, and a method of optically communication.

One aspect of the present invention is a cats-eye MRR assembly, which includes a cats-eye MRR. The cats-eye MRR can include a modulator for modulating a received interrogating light beam, an optical focusing device, such as a compound lens or telecentric lens, for focusing the received interrogating light beam to the modulator, and a reflector for reflecting the modulated light beam. The cats-eye MRR assembly further includes at least one of an angle of arrival sensor spaced from the cats-eye MRR or a beam deflector.

The beam deflector is positioned at an optical aperture of the cats-eye MRR to coarsely deflect the received interrogating light beam to the focusing device of the cats-eye MRR. The beam deflector reduces the field of view (FOV) of the cats-eye MRR needed for intercepting an interrogating light beam from a transmitter without changing the operational FOV needed for the cats-eye MRR assembly to intercept the interrogating light beam from the transmitter. The beam deflector can comprise at least one of cascaded liquid crystal switchable prisms, MEMS based micromirror arrays that function as blazed gratings, or Risley prisms.

The light modulator can be a non-switched or switched multiple quantum well (MQW) electro-absorption modulator. The switched MQW modulator is pixelated to allow the light sensitivity of the MQW to sense or detect the interrogating light beam incident on at least one pixel thereof at any given moment and direct a modulation signal to the at least one pixel. Alternatively, the angle of arrival sensor can sense or detect the angle of arrival of the interrogating light beam incident on the modulator to control or identify a region of the modulator to be selectively activated, The angle of arrival sensor also can control the beam deflector based on the angle of arrival detected.

The angle of arrival sensor can comprise a lens and a photodetector placed away from the focal plane of the lens to defocus an optical spot or at the focal plane of the lens. The lens can have a focal length of F_{L}=R*F_{OFD}, where F_{OFD} is the focal length of the optical focusing device of the cats-eye MRR and R is a factor greater than zero. If R is one for example, the focal length of the lens of the angle of arrival sensor equals the focal length of the optical focusing device of the cats-eye MRR. The photodetector can comprise a continuous photodetector that outputs a signal proportional to the position of an optical spot on the surface of the modulator or a pixelated array of photodetectors that can be individually turned on and off

Another aspect of the present invention is an optical communication system having a first terminal including a transmitter for transmitting an interrogating light beam and the receiver for receiving the interrogating light beam, and a second terminal including the cats-eye modulating retro-reflector (MRR) assembly described above.

The second terminal can have a gimbal pointing device. The second terminal itself can be mounted to the gimbal pointing device or the cats-eye MRR assembly can be mounted to the gimbal pointing device, which itself can be mounted to the second terminal. The angle of arrival sensor can control the gimbal pointing device to coarsely align the optical axis of the cats-eye MRR to the interrogating light beam from the transmitter.

Another aspect of the present invention is a method of optically communicating between the first terminal and the second terminal. The method can include providing the angle of arrival sensor spaced from the cats-eye MRR at the second terminal, detecting the angle of arrival of the interrogating beam at the second terminal with the angle of arrival sensor, activating a pixel of the pixelated modulator based on the detection of the angle of arrival to permit the activated pixel to modulate the interrogating beam, and reflecting the modulated interrogating beam to the receiver.

The method can further include providing the beam deflector at the optical aperture of the cats-eye MRR. The method can further include controlling the beam deflector or the gimbal pointing device based on the detection of the angle of arrival.

### BRIEF DESCRIPTION OF THE DRAWINGS

FIG. 1 schematically illustrates an optical system according to the present invention.

FIG. 2 schematically illustrates the modulator size of a catseye MRR depending on the product of the optical aperture and the field of view (FOV) with a proportionality factor that depends on the F-number of the optic.

FIG. 3 schematically illustrates a cats-eye MRR with a telecentric lens as a focusing device.

FIG. 4 schematically illustrates a cat-eye MRR with a different embodiment of compound lens as a focusing device.

FIG. 5 schematically illustrates one embodiment of a beam deflector for the cats-eye MRR assembly, with the beam deflector in an unactivated state.

FIG. 6 schematically illustrates the beam deflector o FIG. 5 in an activated state.

FIG. 7 schematically illustrates another embodiment of a beam deflector for the cats-eye MRR assembly.

FIG. 8 schematically illustrates a cats-eye MRR assembly according to the present invention, with an incident beam at one extreme angle.

FIG. 9 schematically illustrates the cats-eye MRR assembly of FIG. 8, with the incident beam perpendicular to thereto.

FIG. 10 schematically illustrates the cats-eye MRR assembly of FIG. 8, with the incident beam at the other extreme angle.

FIG. 11 schematically illustrates the second terminal of FIG. 1 with a separate angle of arrival sensor.

FIG. 12 schematically illustrates a front view of the second terminal of FIG. 11.

FIG. 13 schematically illustrates the second terminal mounted to a gimbal pointing device or only the cats-eye MRR assembly mounted to the gimbal pointing device, which is mounted to the second terminal.

### DETAILED DESCRIPTION

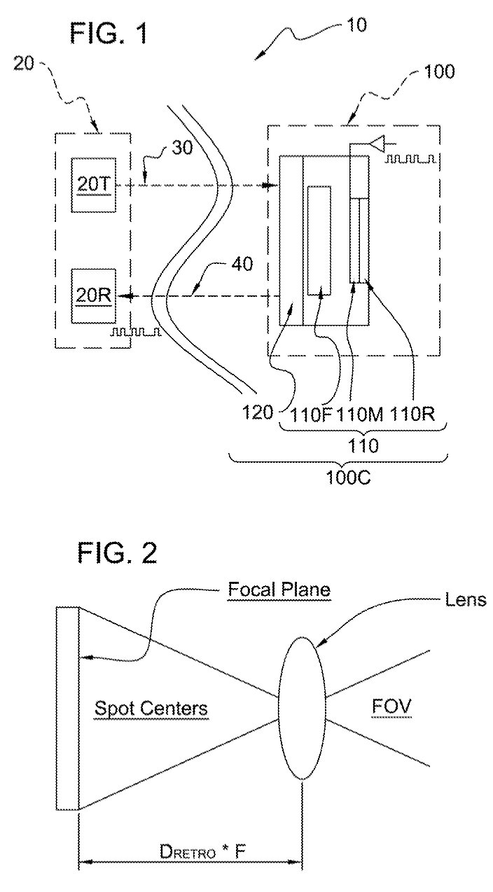

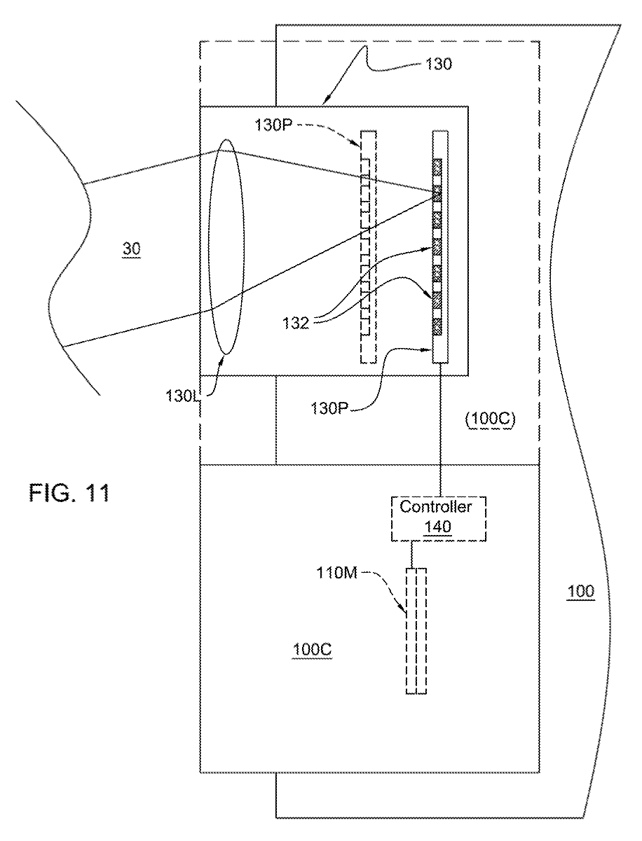

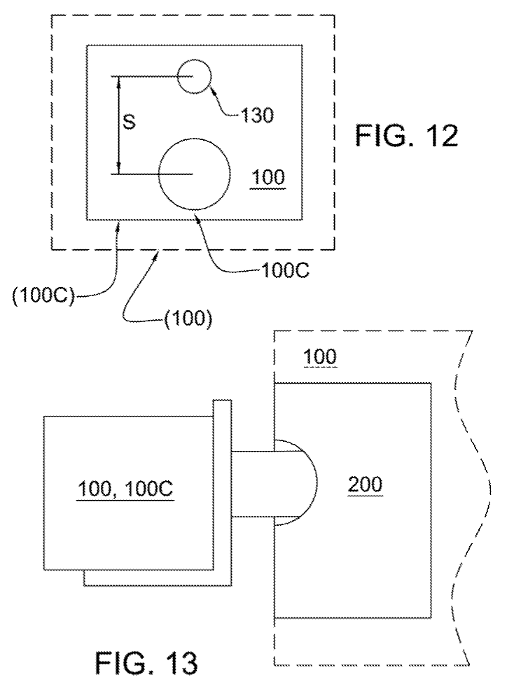

Referring to FIG. 1 an optical communication system 10 according to an embodiment of the present invention includes a base station or first terminal 20 and a remote or distal station or second terminal 100. The first terminal 20 can include a transmitter 20T and a receiver 20R. The transmitter 20T transmits an interrogating light beam 30) such as a CW beam, to the second terminal 100 and the receiver 20R receives the interrogating light beam 40 that has been modulated and retro-reflected at the second terminal 100. The second terminal 100 can include a cats-eye modulating retro-reflector (MRR) assembly 100C, which includes a cats-eye MRR 110. The assembly 100C also includes a beam deflector 120 for coarsely deflecting or steering the interrogating light beam 30 from the transmitter 20T to the cats-eye MRR 10. The assembly 100C also can include an angle of arrival sensor 130. See FIGS. 11 and 12.

The cats-eye MRR 110 can include an optical focusing device 110F, a light modulator 110M, such as a m multiple quantum well (MQW) electro-absorption modulator (hereafter MWQ modulator), and a retro reflector 110R, such as a mirror. The light modulator 110M modulates the received interrogating light beam 30 and the reflector 110R retro reflects the modulated interrogating beam 40 to the transmitter 20T The optical focusing device 110F, which comprises at least one optical lens, focuses the interrogating light beam 30 from the transmitter to one surface of the light modulator 110M that is positioned perpendicular to the optical axis of the catseye MRR.

The beam deflector 120, which coarsely steers the interrogating light beam 30 from the transmitter 20T to the optical focusing device 110F, is positioned at the optical aperture of the optical focusing device 110F, i.e., in front of the optical focusing device 110F. The combination of the cats-eye MRR 110 and the beam deflector 120 mutually enhances the advantageous features of each other. Specifically, the cats-eye MRR 110 provides an effective fine steering mechanism, which is hard to achieve with many beam deflector, while the beam deflector 120 provides coarse steering that reduces the FOV that the cats-eye MRR 110 must cover without changing the overall operational FOV the cats-eye MRR assembly 100C. The reduction in the cats-eye MRR FOV needed to cover by the beam deflector 120 can dramatically reduce the cost and complexity while permitting usage of higher performance optics.

The cats-eye MRR 110 itself is disclosed in the afore-mentioned U.S. patent, the disclosure of which is incorporated herein by reference. The cats-eye MRR in general has different scaling rules than conventional free space optical links. These rules are determined by the fact that the cats-eye MRR acts simultaneously as a receiver and a transmitter. Thus, the larger the cats-eye MRR aperture, the more light from the interrogating beam it captures and the narrower its return beam divergence is. The optical signal returned by the cats-eye MRR scales can be expressed as follows:

$$\frac{{P}_{laser} \cdot {D}_{retro}^{4} \cdot {D}_{rec}^{2}}{{θ}_{div}^{2} \cdot {R}^{4}} \cdot [ 1 - \frac{1}{{N}_{ext}} ] {e}^{- 2 {α}_{mod} {L}_{mod}} {e}^{- 2 {α}_{atm} R} , \qquad ( 1 )$$

where Pₗₐₛₑᵣ is the power in the interrogating laser, Dᵣₑₜᵣₒ is the optical aperture of the retro-reflector, D_{rec} is the diameter of the interrogaor's receive telescope, θ_{div} is the divergence of the outgoing beam from the interrogator, R is the range, Nₑₓₜ is the extinction ratio of the modulator, α_{mod} is the absorption in the modulator, L_{mod} is the thickness of the modulator, and αₐₜₘ is the absorption or scattering loss in the atmosphere.

Expression (1) contradicts the scaling relations one would expect for a conventional long-range optical link, where the dependence on both the aperture and range generally approaches as second powers. When the atmospheric attenuation is not severe, however, the cats-eye MRR link is dominated by the two fourth power relations in expression (1). The link drops off with range as 1/R⁴. The optical signal, however, increases as the fourth power of the retro-reflector diameter. Accordingly, it is highly desirable to use a larger cats-eye MRR. For a MQW modulator, however, the capacitance is proportional to the area of the modulator, so that maximum modulation rate scales can be expressed as follows:

1/R_{mod}D_{mod}² (2)

where R_{mod} is the sheet resistance and D_{mod} the diameter of the MQW modulator. For a typical MQW modulator, capacitances are about 5 nF/cM² and sheet resistances can vary between 10 and 100 Ohms. Thus, the RC modulation limit for an MQW modulator ranges from 1-20 MHz/cm² for centimeter-sized apertures.

This RC problem can be circumvented by pixelating the modulator into smaller segments, with lower capacitance, and driving those segments with separate drivers carrying the same signal. This approach still does not reduce the power consumption of the modulator, which scales as follows:

D_{mod}²V²f (3)

where V is the driving voltage for the modulator and f is the modulation rate. This power consumption can become large for high data rates and the heating it induces in the MQW modulator can undesirably distort the retro-reflected beam, ruining the link.

Given the scaling rules described above, there is a problem in achieving long range, high data rate MRR links. These links require a high MQW modulation speed, driving one toward smaller modulators while at the same time requiring a higher retro-reflected optical signal, driving one toward larger optical apertures. This is impossible for a corner-cube based MRR described in the afore-mentioned U.S. patent for which the modulator size must equal the optical aperture. One of the ways to solve this problem is to use a lens or optical device to increase the optical aperture, as is disclosed in the afore-mentioned U.S. patent Placing the modulator in the focus of the lens maintains a larger optical aperture and a small modulator aperture simultaneously.

While the modulator can be placed at the focus, allowing it to be small, one must now deal with the fact that the focal point varies with the angle of incidence. In effect, for a corner cube MRR, the modulator aperture, must equal the optical aperture, whereas for the cats-eye MRR, the modulator size depends on the product of the optical aperture and the field of view (FOV) with a proportionality factor that depends on the F-number (focal ratio) of the optic. See FIG. 2.

There are several ways to handle the spot wander in the focal plane. One is to limit the FOV that the cats-ye MRR must handle, which will automatically limit the size of the MQW modulator required. The entire MQW modulator can be driven with the signal. This is referred to as a non-switched MQW modulator. A more sophisticated approach, as described in the afore-mentioned U.S. Patent, is to use a switched MQW modulator, i.e., pixelated. The light sensitivity of the MQW modulator can be used to sense where the focal spot is at any given moment, The modulation signal need only be directed to the illuminated pixel instead of driving the entire MQW modulator, In this switched cats-eye approach, the MQW modulator will still need to be large enough to cover the focal plane, but its power consumption will be low because only a portion of it is driven at any given time.

The cats-eye MRR FOV is defined both by the FOV over which the cats-eye optic retro-reflects and the size of the MQW modulator in the focal plane. The entire focal plane of the optic can be simply viewed as a circle whose radius is the distance of the focal spot from the optical axis when the cats-eye MRR is illuminated by a beam at the maximum angle over which it can retro-reflect, While the cats-eye MRR can still retro-reflect even if the MQW modulator does not cover the entire focal plane, it cannot send information, since the interrogating beam will not pass through the modulator pixel. When the MQW modulator is smaller than the focal plane, the effective FOV is limited by the size of the MQW modulator. On the other hand, if the MQW modulator is larger than the focal plane over which the optic return-reflects, the FOV is limited by the optics.

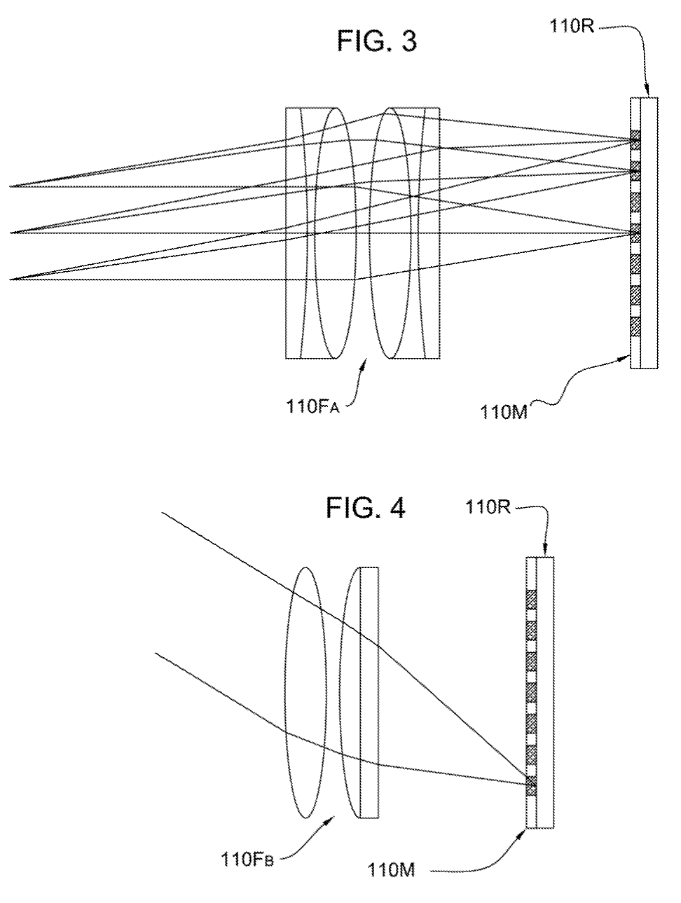

Referring to FIG. 3, the optical focusing device 110F of the cats-eye MRR 110 can comprise a telecentric lens 110F_{A}, which produces a ray bundle in the focal plane that is symmetric around the optical axis regardless of the angle of incidence, or other compound type of lens 110F_{B} (see FIG. 4). The reflector 110R can comprise a flat mirror placed adjacent to the MQW modulator 110M, which can be positioned on the focal plane of a telecentric lens, to retro-reflect light. The mirror simply inverts the ray bundle passing through the MQW modulator. Note that the beam paths refracting through the lens as illustrated in FIGS. 3-11 are merely for generally illustration and do not accurately depict the actual beam paths.

To examine the performance of the cats-eye MRR 110 that uses a telecentric lens, as illustrated in FIG. 3, an experimental cats-eye MRR was made using a sparse linear array of MQW pixels placed at the focal plane of the telecentric lens. The array consisted of three 1 mm diameter MQW pixels with a center-to-center separation of 2.5 mm, or 1.5 mm spacing between the pixels. The array covered a discontinuous FOV of 12.5°×2.5° with a field of view of 2.5°×2.5° for each pixel. Such an array can be useful when several interrogators dispersed over a wide field simultaneously illuminate the cats-eye MRR.

The MQW modulator of the experimental cats-eye MRR consisted of 75 periods of 8.5 nm InO.I7GaO.83As (atomic number mole fraction) wells separated by 3.4 nm Al0.I3GaO.87As (atomic number mole fraction) barriers. The MQW modulator was grown via molecular beam epitaxy on a GaAs substrate. The exciton resonance for this structure fell at 980 nm, a wavelength at which the GaAs substrate is transparent. This allowed the MQW modulator to be placed in front of a flat mirror, while allowing the interrogating CW beam to pass therethrough, Alternatively, a reflective coating can be deposited on the wafer itself instead of a flat mirror.

The experimental cats-eye MQW modulator exhibited a 3 dB bandwidth of 25 MHz, far higher than corner cube based devices, which have a maximum rate of about 7 MHz. The optic, however, had some drawbacks, including a relatively high F-number (f/4) and a non-diffraction-limited return. The former requires a large MQW array to cover a given FOV while the latter property limits the strength of the retro-reflected signal.

To overcome these deficits, the telecentric lens was replaced with a diffraction limited optics. This replacement optical device had a 1.6 cm aperture, diffraction limited return over 30 degrees and an F/number of 2.0 (f/2). This diffraction limited optics had 4 elements including one aspheric element. It also used a curved reflector with a pixelated MQW array in front of the reflector, similarly as illustrated in FIG. 6 of the afore-mentioned patent. To cover the full 30-degree, the FOV of the optics would require a large 1.4×1.4 cm MQW array. Instead, an 8 mm×8 mm array with rectangular pixels designed to reduce sheet resistance was used.

The pixels for this experimental MRR with the diffraction limited optics could be driven at a top speed of 15 Mbps, which is slower than that of the cats-eye MRR with a telecentric lens, but with a much larger optical return so that a long-range link was possible. Using this cats-eye MRR with the diffraction limited optics, a 10 Mbps link over 2 Km at Chesapeake Bay, Md. was possible.

The complexity of cats-eye MRRs is most closely related to the size and number of pixels in the MQW modulator focal plane, The larger the MQW modulator, the more expensive it becomes. In addition, the larger the MQW modulator, the lower the yield since defects in the semiconductor material become more likely. The number of pixels affects the complexity of the wiring scheme and also of the electronics that must switch the drive voltage from one pixel to another. In general, MQW arrays with fewer than 16 pixels are relatively straightforward to make, but as the number of pixels increases beyond that complexity increases dramatically.

For a fixed optic, the area of the MQW modulator array increases as follows:

Dᵣₑₜᵣₒ²FOV² (4)

where Dᵣₑₜᵣₒ is the optical aperture and FOV is that of the MRR in radians, assumed the same in both dimensions.

The number of pixels required in the MQW modulator backplane scales as follows:

Dᵣₑₜᵣₒ²FOV²f (5)

where f is the communications bandwidth of the MQW.

Given a fixed communications bandwidth, the way to reduce the size and number of pixels of the MQW is to reduce the optical aperture or the FOV. As shown in expression (1), the optical power returned by the MRR scales as Dᵣₑₜᵣₒ⁴ so that reducing the optical aperture will severely restrict the range of the device. In some applications, however, reducing the FOV can be a viable option. For example, in a fixed point building to building link, the FOV generally only needs to be a few milliradians to accommodate building sway. In many applications, however, such as between moving platforms, a wider FOV is needed.

One way around this bottleneck is to distinguish between the system FOV, which is the FOV of the link (i.e., the cats-eye MRR assembly), and the cats-eye MRR FOV, which is the FOV of the tight entering the cats-eye MRR. If the cats-eye MRR FOV can be restricted while keeping the system FOV large, then a wide angle cats-eye MRR with a small MQW focal plane can be achieved, The present cats-eye MRR assembly 100C can achieve this goal.

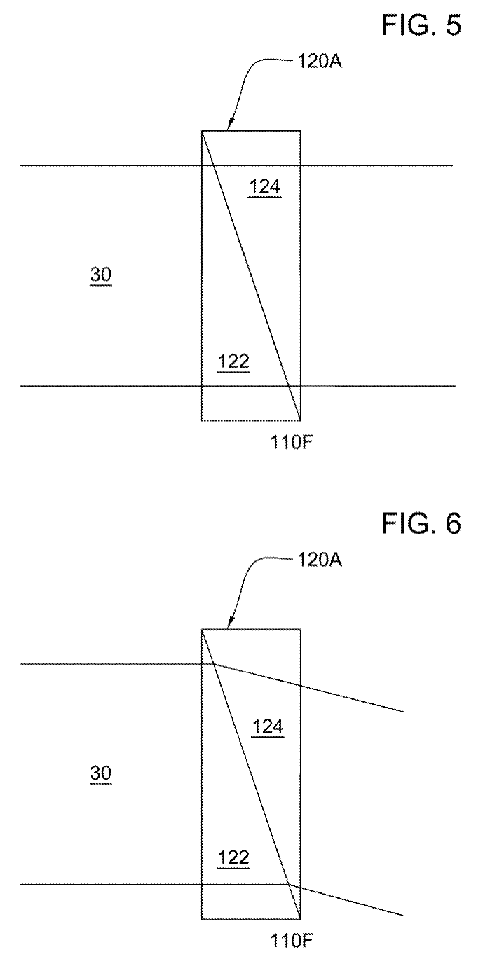

A variety of coarse mechanical and non-mechanical optical beam deflecting or steering devices exist. These include cascaded liquid crystal switchable (LCS) prisms, MEMS based micromirror arrays that function as blazed gratings, and Risley prisms. FIGS. 5-6 schematically illustrate how one embodiment 120A of the beam deflector 120, namely LCS prisms, operates. The beam deflector 120A comprises first and second LCS prisms 122, 124, having the same geometric configuration and the same index of refraction, cascaded so that the opposing surfaces of light incidences are parallel, i.e., both opposing surfaces thereof are positioned parallel to the beam incident surface of the modulator. In this embodiment, the beam is undefleted when neither of the LCS prisms is activated. See FIG. 5. When an electric field, however, is applied to one of the prisms, the index of refraction of the one prism is changed, resulting in the beam being deflected into an angle determined by the prism shape and their index of refraction difference as shown in FIG. 6. If the field is applied to the other prism, beam deflection in the opposite direction can occur. Thus, this mechanism can provide two readily accessible angles.

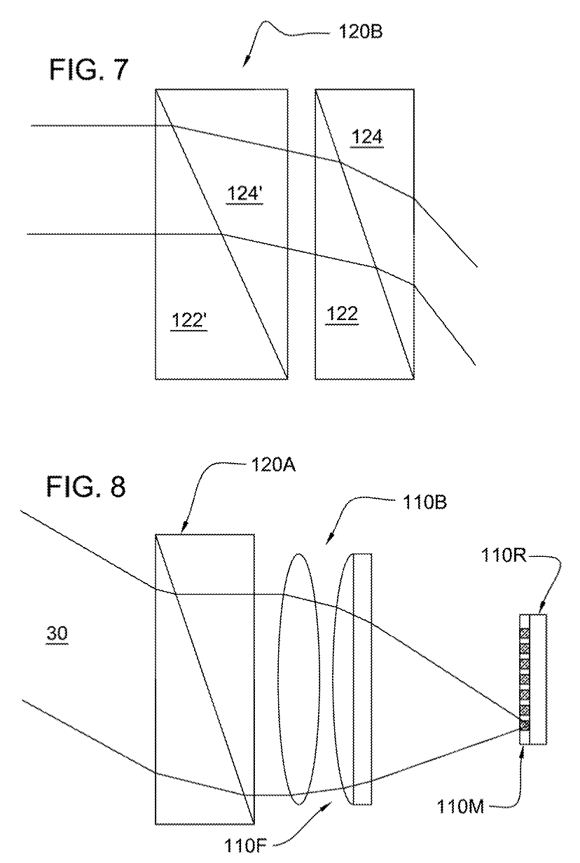

FIG. 7 illustrates a second embodiment 1208 of the beam deflector 120. Here, the second embodiment 1208 comprises two or more of the beam deflectors 120A, 120A′ illustrated in FIG. 5. Cascading the beam deflectors 120A, 120A′ can reduce the optical efficiency, but it increases the number of accessible angles. If the second prism 124′ 124 of each beam deflector 120A′, 120A has a different shape or index of refraction than the first prism 122, 122′, then this embodiment will provide 8 different angles by selectively activating the four prisms 122′, 124′, 122, 124. These prisms can be selectively activated based on the angle of arrival detected with the angle of arrival sensor 130. See FIGS. 11-12.

In general, like liquid crystal prisms, beam deflecting devices can only access a finite number of discrete deflection angles or, in the case of Risley prisms, are limited in their fine pointing accuracy by mechanical considerations. This limitation means that these devices are not useful for free space optical communications unless they are combined with a fine steering device.

FIG. 4 illustrates a cats-eye MRR, with a beam impinging on it at a high angle. The focal spot is well off the optical axis of the catseye MRR, requiring a large MQW modulator to intercept it. If this angle were the largest one at which the optic would retro-reflect, then the MQW modulator shown would be of a sufficient size to permit the MRR operate at all incident angles at which the optic can retro-reflect. A beam deflector 120 (120A, 120B) can be used to reduce the required size of the MQW modulator while still allowing a large FOV. For example, assuming that the cats-eye optics in which the focal spot position off the optical axis can be expressed as follows:

Zₛₚₒₜ=ζ_{CE}θ_{mc} (6)

where Zₛₚₒₜ is the radial distance of the focal spot off the optical axis, ζ_{CE} is a proportionality constant that depends on the optic, and θ_{inc} is the incident angle of the beam on the optic, then for a cats-eye optic with a full FOV θ_{F}, the MQW modulator would need to have a radius of ζ_{CE}θ_{F}/2. Placing a discrete beam deflector, which is a device that can only deflect into a fixed set of angles, with the deflection angle assumed to be along one axis only, in front of the cats-eye aperture, can deflect the beam. Note that many beam deflection devices can be cascaded to allow two dimensional operation, as illustrated in FIG. 7.

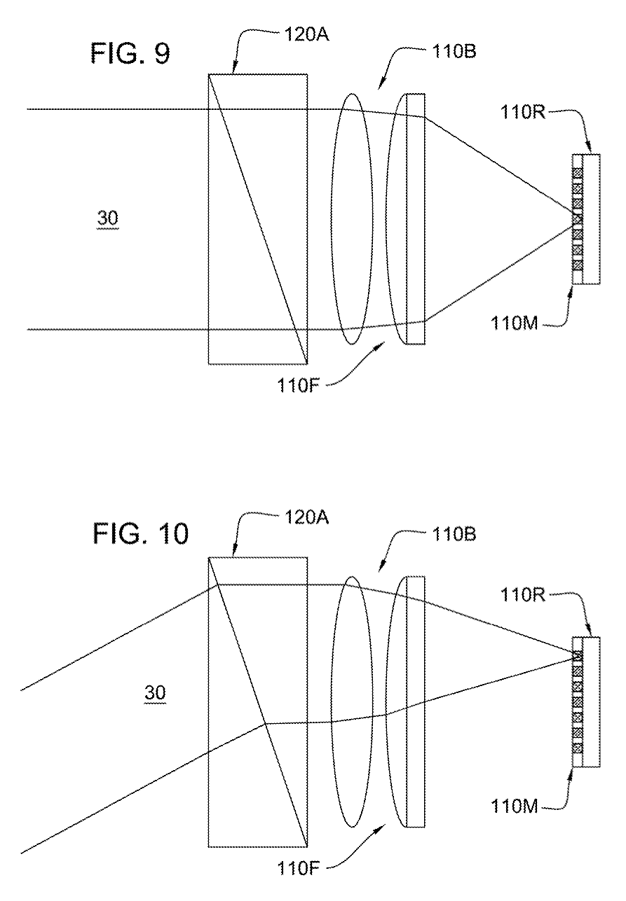

For expediency of explanation, the deflector is assumed to deflect to three different angles, 0° meaning it is set to no deflection, −θ_{D}, and θ_{D}. Specifically, if the beam deflector 120 is in front of the cats-eye optical aperture, then it operates as follows. Referring to FIG. 8, for incident beams with angles between −θ_{F}/2 to −θ_{F}/2+θ_{D}, the beam deflector can be set to deflect by an angle of +θ_{D}, shifting the incident angle onto the cats-eye to −θ_{F}/2+θ_{D} to −θ_{F}/2+2θ_{D} Referring to FIG. 9, for incident beams with angles between −θ_{F}/2+θ_{D} to θ_{F}/2−θ_{D}, the beam deflector can be set to no deflection. Referring to FIG. 10, for incident beams with angles between θ_{F}/2−θ_{D} to θ_{F}/2, the beam deflector can be set to deflect by an angle of −θ_{D}, shifting the incident angle onto the cats eye to θ_{F}/2−2θ_{D} to θ_{F}/2−θ_{D}. With this arrangement, the system FOV remains at θ_{F}, but the maximum range of angles entering the cats-eye MRR will be reduced to θ_{F}−2θ_{D}. This reduction in MRR FOV allows the required size of the MQW modulator and the number of pixels to be reduced by the ratio (θ_{F}−2θ_{D})/θ_{F}.

As an example, considering the cats-eye MRR link with a required system FOV of 32° and a beam deflector capable of deflecting ±8°, for beams 30 incident with angles between −16° and −8°, the deflector can be set to its +8° state based on the detection of the angle of arrival detected by the angle of arrival sensor 130, shifting the range of angles entering the cats-eye to −8° to 0°. For the middle range between −8° to +8°, the beam can be left undeflected. For the high range between 8° and 16°. The deflector can be set to −8° and the beams incident on the cats-eye optic can be shifted to 0° to 8°. The system or the link FOV remains 32° but the MRR FOV will be reduced to 16°. The required length of the cats-eye along the deflection direction will be reduced by 50%, and the required number of pixels or the size can be reduced by 50%.

Cascading two beam deflectors oriented 90° with respect to each other can provide a significant enhancement since the size of the MQW could be reduced in both dimensions, reducing the required number of pixels by the square of one deflector alone. Cascading multiple deflectors as a way of increasing the number of addressable angles, however, may or may not provide an advantage. When the maximum deflection angle is less than the half the system FOV, as in the example above, there will be no advantage to more than 3 addressable angles in each dimension, When the maximum deflection angle, however, exceeds half the system FOV then there will be an advantage to more addressable angles.

For example, considering the same beam deflector as above used in a system with a full FOV of 20° operating in the same mode as above, then when the incident angle is between −10° to −2° the deflector can be set to +8°, shifting the incoming beam to the range −2° to +6°. Between −2° and +2° the beam can be left undeflected, and from +2° to +10° the beam can be set to deflect −8° to the range −6° to +2°. In this case, the cats-eye MRR must cover a field of 8° from −6° to +6°, a full field of 12°.

If on the other hand, the beam deflector had more addressable spots, for example −8°, −4°, 0°, 4° and 8°, then it is desirable to restrict the cats-eye MRR FOV to a smaller value. For example, when the incident angle is between −10° to −6° the deflector can be set to +8°, shifting the incoming beam to the range −2° to +2°. When the incident angle is between −6° to −2° the deflector can be set to +4°, shifting the incoming beam to the range −2° to +2°. When the incident angle is between −2° to 2° the deflector can be set to 0. When the incident angle is between +2° to +6° the deflector can be set to −4°, shifting the incoming beam to the range −2° to +2°. When the incident angle is between 6° to 10° the deflector can be set to −8° shifting the incoming beam to the range −2° to +2°. Using this approach, the cats-eye MRR FOV can be restricted to a full field of 4°, a three times improvement over a beam deflector with fewer addressable spots.

In all these cases, the system FOV is kept constant while the cats-eye MRR FOV is reduced. A small cats-eye MRR FOV means that a smaller MQW modulator with fewer pixels can be used. Alternatively, it can allow a system with the same total number of pixels, but ones that are smaller and hence faster. It also can reduce the weight, cost, and complexity of the cats-eye optic. In the current diffraction limited cats-eye optical design, covering a full 30° FOV makes it considerably more difficult to optimize the optics. In the cats-eye MRR assembly 1000 according to the present invention, the cats-eye MRR optics would have a smaller FOV to cover the same and could be made simpler. In addition, this can allow the cats-eye MRR optics to have a lower F-number, further reducing the required size of the MQW modulator.

While the exemplary embodiments illustrate a liquid crystal prism beam deflector, the present optical communication system is not limited thereto. Many different types of beam deflectors, either using liquid crystals in other configurations or other types of devices such as MEMS, can be used. In addition, the present approach can be advantageous with certain kinds of mechanical beam steering, such as Risley prisms or even using body pointing on a moving platform, such as a gimbal pointing device, as a crude pointing device. See FIG. 13.

It is important to note that the beam deflector 120 need not be very accurate or repeatable. All the fine steering is done by the cats-eye MRR, which itself is not mechanically coupled to the coarse beam deflector. If, for example, the deflector's deflection angle varied by even a degree from one deflection to another, it would have no effect on the accuracy of the beam retro-reflected back to the interrogator, although it can cause occasional vingetting at the outer angular range of the device. As long as the beam deflector 120 steers the beam somewhere within the cat-eye MRR FOV it can be retro-reflected. This is particularly important when considering implementing a mechanical beam deflector like a Risley prism. These devices have in principle a continuous angular coverage (with the exception of a dead zone near zero deflection), but may not be particularly accurate in their pointing. When used with a cats-eye retro-reflector MRR this inaccuracy is not a problem.

For the present cats-eye MRR assembly 100C to operate effectively, however, it needs an ability to sense the angle of arrival of the optical beam, in at least a coarse sense, to set the state of the beam deflector. It may also want to know the angle in a finer sense if it wants to direct the modulation signal to just part of the MQW array to save power. As with the cats-eye MRR disclosed in the afore-mentioned U.S. patent, the MQW modulator focal plane itself can be used to sense the angle of arrival. As the beam moves to the edge of the focal plane, however, the circuitry will have to sense the direction it is moving to determine how to set the beam deflector 120. This is different than with the cats-eye MRR where there is a pixel corresponding to every possible angle of incidence on the device. In that case, simply sensing the location of the focal spot is sufficient. For the cats-eye MRR assembly that uses a smaller MQW modulator, there can be angles of incidence that do not fall on any pixel thereof, unless the coarse beam deflector is set appropriately.

As previously mentioned, the present cats-eye MRR assembly 100C includes the cats-eye MRR 110 and the beam deflector 120, which reduces the MRR FOV while maintaining the system FOV. The assembly 100C also can include an external or separate optical angle of arrival sensor 130. See FIGS. 11-12. Note that angle of arrival sensor 130 can be located within the assembly 100C or module thereof housing the elements thereof. That is, the sensor 130, the cats-eye MRR 110, and the beam deflector 120 can be located in the same chassis, frame, or module so that these elements can be mounted to the second terminal as a unit. The sensor 130 also can be mounted to the second terminal, separate from the assembly 100C. Since the interrogating beam illuminating the cats-eye MRR generally illuminates a much larger area than the cats-eye, a separate co-aligned angle of arrival sensor can be set next or adjacent to the cats-eye optic with no loss in the returned optical power. This angle of arrival sensor can take many forms but two of them are illustrated.

Referring to FIG. 11, one embodiment of the angle of arrival sensor 130 can comprise a lens 130L, which can be a simple lens, and a photodetector 130P placed in or at the focal plane of the lens 130L. The lens 130L can have a focal length of F_{L}=R*F_{OFD}, where F_{OFD} is the focal length of the optical focusing device 110F of the cats-eye MRR and R is a factor 1 or greater than zero. If R is 1, then the focal length of the lens 130L is equal to the focal length of the focusing device of the cats-eye MRR. In that case, the geometric configuration of the photodetector 130P merely matches the geometric configuration of the cats-eye modulator pixels. Alternatively, if R is greater than zero (other than 1), the geometric configuration of the photodetector matches the geometric configuration of the cats-eye modulator pixels by a factor R. For example, if the focal length of the angle of arrival lens 130L is half (0.5) that of the optical focusing device of the cats-eye MRR, the photodetector 130P will be half the length and half the width of the cats-eye modulator, When a photodetector 130P of the angle of arrival sensor 130 is illuminated to a predetermined set value or higher, the position corresponding to the cats-eye modulator pixel is turned on. Alternatively, the photodetector 130P can be positioned away from the focal plane of the lens 130L as illustrated in phantom in FIG. 11. This will defocus the optical spot and turn on a larger area so that more than one photodetector pixels can be turned on, which can be advantageous in preventing rapid signal transitions as the angle of arrival changes.

The photosensor 130P can comprise a large continuous photodetector that outputs a signal proportional to the position of an optical spot on the beam incident surface of the modulator, Alternatively, the photodetector 130P can comprise a pixelated array of photodetectors 132, similar to the cats-eye modulator pixels. as illustrated in FIG. 11. The pixelated photodetector 130P can have a particular pixel corresponding to a particular incident angle. By sensing the illuminated pixel(s) of the photodetector 130P, the angle of arrival can be determined. Either of these sensors or any other type of angle sensor can be positioned next to the cats-eye MRR but not behind the beam deflector 120. In this respect, FIG. 12 illustrates the angle of arrival sensor 130 spaced by a spacing S (center-to-center) from the cats-eye MRR. They both need to see the entire system FOV, not just the cats-eye MRR FOV The spacing S should not exceed to a point where it falls outside the region of the interrogating beam 30. As previously mentioned, the region of the interrogating beam 30 is substantially larger than the optical aperture of the cats-eye MRR, particularly so if the distance between the first and second terminals is great.

The cats-eye MRR 110 also can include an embedded microprocessor or a separate controller 140 that can control the modulator activation and the beam deflector, namely selectively turning on and off the modulator pixels and selectively activating one or more LCS prisms 122, 124, 122′, 124, etc. based on the illumination state of the angle of arrival sensor 130. Also, rather than a fixed illumination threshold, the cats-eye modulator pixel corresponding to the angle of arrival photodetector or photodetector pixels with the highest illumination can be turned on,

There are several advantages to sensing the angle of arrival outside of the cats-eye MRR. First, the position sensitive continuous-type or type-type photodetector 130P is less expensive than the MQW modulator. Thus, the photodetector 130P can be made larger to cover the FOV. In addition, a smaller, shorter focal length lens can be used in the angle of arrival sensor 130 to allow it to be made smaller than the cats-eye MQW modulator 110M, while still covering the entire system FOV.

Another advantage of a separate angle of arrival sensor applies to a conventional cats-eye MRR that does not use a beam deflector. When both the angle sensing function and the modulation function are combined into a single device as disclosed in the afore-mentioned U.S. Patent, they can interfere with each other. In particular, the large currents needed to modulate can mask the small photocurrents that must be detected for the angle-of-arrival sensing function, By separating the two functions, each unit can be optimized for its own function, namely allowing use of a higher contrast MQW modulator for modulation and a more sensitive photodetector for angle-of-arrival sensing, Thus, another aspect of the present invention is a conventional cats-eye MRR that uses a separate angle of arrival sensor.

The catseye MRR assembly 100C an have many advantages. Combining the automatic fine steering ability of a retro-reflector and a beam deflector provides a synergistic effect, which produces capabilities that neither of these devices possesses on their own. From the point of view of the cats-eye MRR, the beam deflector can greatly reduce the FOV that the cats-eye MRR itself must cover while maintaining the system FOV. The reduced cats-eye MRR FOV is advantageous in at least four ways.
1. Reduction of the required size of the cats-eye MQW modulator, reducing cost and increasing yield.
2. Reduction in the number of pixels needed to provide a given amount of bandwidth, reducing complexity.
3. Allowing the same number of smaller pixels to provide more bandwidth,
4. Allowing a larger cats-eye optical aperture without increasing the size of the cats-eye MRR focal plane, thus increasing the amount of light returned by the retro-reflector.

With current technology, about an order of magnitude increase in speed or decrease in complexity could be achieved. From the point of view of the beam deflector, the addition of the retro-reflector allows an optical communication system that is much simpler than otherwise possible. The retro-reflector provides the equivalent of a laser source and a fine pointing and tracking system with about 30 microradians accuracy (for a 1.6 cm aperture) in a very compact, low power package. When combined with a beam deflector such as LCS prisms, a completely non-mechanical, wide field of view laser-communication terminal results. When combined with a mechanical, but conformal beam steering device like a Risley prism pair, it is possible to make a laser-communication terminal with high pointing accuracy and yet extremely loose mechanical tolerances on the prism pair (accuracy of the prism pair pointing can be as high as ±1°).

Referring to FIG. 13, a conventional mechanical beam steering device 200, such as a gimbal pointing device, also can be extended on the platform on which the cats-eye MRR assembly is mounted to function as a coarse steering device, or the second terminal itself can be mounted thereto, Such a mechanical steering device will have similar inaccuracy as a Risely prism. The angle of arrival sensor also can be used to controls the positioning of the gimbal pointing device to coarsely align the cats-eye MRR to the interrogating light beam.

While the disclosure have been referred to a preferred embodiment where a multiple quantum well (MQW) modulator is used, the present invention is applicable to any cats-eye MRR system where the size of the modulator contributes to cost or complexity or where the pixel size of the modulator is related to its speed.

The present invention can enhance the performance of a cats-eye MRR by reducing the field of view that the device must cover, as well as reducing the size, weight, and cost of cats-eye modulating retro-reflectors. It can also be used to increase the speed or optical aperture of a cats-eye MRR without increasing the size or complexity of the MQW focal plane. In addition, the present invention can reduce the complexity of a cats-eye MRR by separating out the angle of arrival sensing function of the cats-eye MRR into a separate angle of arrival sensor.

Given the disclosure of the present inventions one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

What is claimed is:

1. An optical communication system comprising:
a first terminal having a transmitter for transmitting an interrogating tight beam and a receiver for receiving the interrogating light beam; and
a second terminal having a cats-eye modulating retro-reflector (MRR) assembly, which includes a cats-eye MRR,
wherein the cats-eye MRR includes a modulator for modulating the interrogating light beam received from the transmitter, an optical focusing device for focusing the interrogating light beam from the transmitter to the modulator and a reflector for reflecting the modulated light beam to the receiver, and
wherein the catseye MRR assembly further includes a beam deflector positioned at an optical aperture of the catseye MRR to coarsely defect the interrogating light beam from the transmitter to the focusing device of the cats-eye MRR.

2. The optical communication system according to claim 1, wherein the beam deflector reduces the field of view (FOV) of the cats-eye MRR needed for intercepting the interrogating light beam from the transmitter without changing the operational FOV needed for the cats-eye MRR assembly to intercept the interrogating light beam from the transmitter.

3. The optical communication system according to claim 2, wherein the beam deflector comprises cascaded liquid crystal switchable prisms.

4. The optical communication system according to claim 1, wherein the optical focusing device includes one of a compound lens or telecentric lens.

5. The optical communication system according to claim 1, wherein the light modulator is a non-switched or switched multiple quantum well (MQW) electro-absorption modulator.

6. The optical communication system according to claim 5, wherein the switched MQW modulator is pixelated to allow the light sensitivity of the MQW to sense the interrogating light beam focused on to at least one pixel thereof at any given moment and direct a modulation signal to the at least one pixel.

7. The optical communication system according to claim 5, wherein the second terminal or the cats-eye MRR assembly further includes an angle of arrival sensor spaced from the cats-eye MRR, the switched MQW modulator is pixelated, and the angle of arrival sensor senses the angle of arrival of the interrogating light beam incident on the modulator to control or identify a region of the modulator to be selectively activated.

8. The optical communication system according to claim 7, wherein the angle of arrival of the interrogating light beam sensed by the angle of arrival sensor also controls the beam deflector.

9. The optical communication system according to claim 8, wherein the angle of arrival sensor comprises a lens and a photodetector positioned away from the focal plane of the lens to defocus an optical spot or at the focal plane of the lens.

10. The optical communication system according to claim 9, wherein the lens has a focal length of F_{L}=R*F_{OFD}, where F_{OFD} is the focal length of the optical focusing device of the cats-eye MRR and R is a factor greater than zero.

11. The optical communication system according to claim 10, wherein the photodetector comprises a continuous photodetector that outputs a signal proportional to the position of an optical spot on the surface of the modulator or a pixelated array of photodetectors that is individually turned on and off

12. An optical communication system comprising:
a first terminal having a transmitter for transmitting an interrogating light beam and a receiver for receiving the interrogating light beam; and
a second terminal having a cats-eye modulating retro-reflector (MRR) assembly, which includes a cats-eye MRR,
wherein the cats-eye MRR includes a modulator for modulating the interrogating light beam received from the transmitter an optical focusing device for focusing the interrogating light beam from the transmitter to the modulator, and a reflector for reflecting the modulated light beam to the receiver, and
wherein the second terminal or the cats-eye MRR assembly includes an angle of arrival sensor spaced from the cats-eye MRR for sensing the angle of arrival of the interrogating light beam incident on the modulator to identify a region of the modulator to be selectively activated.

13. The optical communication system according to claim 12, wherein the angle of arrival sensor comprises a lens and a photodetector positioned away from the focal plane of the lens to defocus an optical spot or at the focal plane of the lens.

14. The optical communication system according to claim 13, wherein the lens has a focal length of F_{L}=R*F_{OFD}, where F_{OFD} is the focal length of the optical focusing device of the cats-eye MRR and R is a factor greater than zero.

15. The optical communication system according to claim 14, wherein the photodetector comprises a continuous photodetector that outputs a signal proportional to the position of an optical spot on the surface of the modulator or a pixelated array of photodetectors that is individually turned on and off.

16. The optical communication system according to claim 12, further including a gimbal pointing device, wherein the cats-eye MRR is mounted to the gimbal pointing device and the angle of arrival sensor controls the gimbal pointing device to coarsely align the cats-eye MRR to the interrogating light beam.

17. The optical communication system according to claim 12, further including a gimbal pointing device, wherein the second terminal is mounted to the gimbal pointing device and the angle of arrival sensor controls the gimbal pointing device to coarsely align the cats-eye MR R to the interrogating light beam.

18. A cats-eye modulating retro-reflector (MRR) assembly for optical communication, comprising:
a cats-eye MRR comprising a modulator for modulating a received interrogating light beam, an optical focusing device for focusing the received interrogating light beam to the modulator, and a reflector for reflecting the modulated light beam; and
a beam deflector positioned at an optical aperture of the optical focusing device of the cats-eye MRR for coarsely deflecting the received interrogating light beam to the optical focusing device of the cats-eye MRR.

19. The cats-eye MRR assembly according to claim 18, further including an angle of arrival sensor spaced from the cats-eye MRR for sensing the angle of arrival of the interrogating light beam incident on the modulator to control a region of the modulator to be selectively activated and to control the beam deflector.

20. The cats-eye MRR assembly according to claim 19, wherein the angle of arrival sensor comprises a lens and a photodetector positioned away from the focal plane of the lens to defocus an optical spot or at the focal plane of the lens.

21. The cats-eye MRR assembly according to claim 20, wherein the lens has a focal length of F_{L=R*F}_{OFD}, where F_{OFD} is the focal length of the optical focusing device of the catseye MRR and R is a factor greater than zero.

22. The cats-eye MRR assembly according to claim 21, wherein the photodetector comprises a continuous photodetector that outputs a signal proportional to the position of an optical spot on a surface of the modulator or a pixelated array of photodetectors that is individually turned on and off.

23. A method of optically communicating between a first terminal having a transmitter for transmitting an interrogating light beam and a receiver for receiving the interrogating light beam and a second terminal having a cats-eye modulating retro-reflector (MRR) assembly, which includes a cats-eye MRR, wherein the cats-eye MRR includes a pixelated modulator for modulating the interrogating light beam received from the transmitter, an optical focusing device for focusing the interrogating light beam from the transmitter to the modulator, and a reflector for reflecting the modulated light beam to the receiver, the method comprising the steps of
providing an angle of arrival sensor at the second terminal, the angle of arrival sensor being spaced from the cats-eye MRR;
detecting an angle of arrival of the interrogating beam at the second terminal with the angle of arrival sensor;
activating a pixel of the pixelated modulator based on the detection of the angle of arrival to permit the activated pixel to modulate the interrogating beam; and
reflecting the modulated interrogating beam to the receiver.

24. The method according to claim 23, further including the step of providing a beam deflector at the optical aperture of the cats-eye MRR to reduce the field of view of the cats-eye MRR needed for intercepting the interrogating light beam from the transmitter without changing the operational FOV needed for the cats-eye MRR assembly to intercept the interrogating light beam from the transmitter.

25. The method according to claim 24, further including the step of controlling the beam deflector based on the angle of arrival detected by the angle of arrival sensor.
